(19) United States
(12) Patent Application Publication
(10) Pub. No.: US 2016/0332491 A1
(43) Pub. Date: Nov. 17, 2016

(54) ROUNDED STONE EJECTORS

(71) Applicant: Bridgestone Americas Tire Operations, LLC, Nashville, TN (US)

(72) Inventors: Aleksandr I. Shmagranoff, Akron, OH (US); David M. Severyn, North Canton, OH (US); Stephen T. Miranda, Copley, OH (US); Todd A. Buxton, Norton, OH (US)

(21) Appl. No.: 15/112,599

(22) PCT Filed: Jan. 27, 2015
(86) PCT No.: PCT/US2015/013044

§ 371 Date: Jul. 19, 2016

Related U.S. Application Data
(60) Provisional application No. 61/935,594, filed on Feb. 4, 2014.

(51) Int. Cl. B60C 11/13; B60C 11/03

(52) U.S. Cl. CPC B60C 11/1353; B60C 11/0309; B60C 2011/1361; B60C 2011/0346

(57) ABSTRACT

A pneumatic tire includes a tread portion having a tread groove having a groove bottom and groove sidewalls. A row of rounded stone ejectors are spaced apart along a length of the groove. Each rounded stone ejector has a base attached to the groove bottom and independent from the groove sidewalls. Each rounded stone ejector has a rounded peak and is continuously tapered from the base to the rounded peak.

### BACKGROUND OF THE INVENTION

1. Field of the Invention

The present invention relates generally to the construction of pneumatic tires, and more particularly, but not by way of limitation, to improved constructions for the stone ejectors located in the tread region of a tire.

2. Description of the Prior Art

One problem encountered in the use of pneumatic tires, and particularly for relatively large tires such as those referred to as truck and bus radial tires which are utilized on eighteen wheeler trucks and on buses, is the entrapment of stones in the relatively large tread grooves of the tires. If a stone is trapped in the tread groove against the bottom of the tread groove, repeated impacting of the stone against the ground surface may cause the stone to cut into or drill into the bottom of the tread groove thus eventually reaching the structural members of the tire and degrading the strength and life of the tire.

Such pneumatic tires often are provided with stone ejectors in the bottom of the tread grooves to aid in preventing such stone entrapment.

There is a continuing need for improvement in the design and construction of such stone ejectors.

### SUMMARY OF THE INVENTION

A pneumatic tire is disclosed having a tread portion including a tread groove having a groove bottom and groove sidewalls. The tread groove has a groove width defined as a shortest distance between the groove sidewalls. The groove has a groove length extending generally parallel to the groove sidewalls. A row of rounded stone ejectors are spaced apart along the groove length. Each of the rounded stone ejectors has a base attached to the groove bottom and independent from the groove sidewalls. Each rounded stone ejector has a rounded peak and is continuously tapered from the base to the rounded peak.

In another aspect of the invention a pneumatic tire is disclosed having a tread portion having a groove defined therein. The groove has a groove cross-section defined by a groove bottom and opposed groove sidewalls. A stone ejector extends upward from the groove bottom and does not contact the groove sidewalls. The stone ejector has an ejector surface, all portions of which are in vertical direction continuously rounded and continuously tapered from a base at the groove bottom to a rounded peak.

In any of the above embodiments at least some of the rounded stone ejectors may be continuously rounded from the base to the rounded peak.

In any of the above embodiments the base may have a periphery, and for at least some of the rounded stone ejectors the entire periphery of the base may be smooth and free of any abrupt changes in tangential direction.

In any of the above embodiments at least one of the rounded stone ejectors may be a spherical stone ejector shaped as a portion of a sphere and the base of each spherical stone ejector is circular.

In any of the above embodiments at least some of the rounded stone ejectors may be elongated rounded stone ejectors, and the base of each elongated rounded stone ejector may be elongated along the groove length, and may have rounded ends.

In any of the above embodiments at least some of the elongated rounded stone ejectors may be elliptical stone ejectors. The base of each elliptical stone ejector may be generally elliptical in shape having a minimum axis substantially parallel to the groove width and having a maximum axis substantially parallel to the groove length.

In any of the above embodiments each of the elliptical stone ejectors may be shaped as a rotation of the elliptical base about the minimum axis of the base.

In any of the above embodiments the base of each of the elongated stone ejectors may have a base length and a base width. The base width may have a maximum base width in a central portion of the base length, and the base width may continuously taper from the maximum base width to each of the rounded ends.

In any of the above embodiments the maximum base width may occur at a mid point of the base length.

In any of the above embodiments adjacent rounded stone ejectors may be spaced apart by a spacing less than a width of the base of either adjacent rounded stone ejector.

In any of the above embodiments each of the rounded stone ejectors may be substantially equally spaced from each of the groove sidewalls, and junctions between the groove bottom and both the base and groove sidewalls may be radiused such that the groove bottom between the base and the groove sidewalls is completely curved.

In any of the above embodiments the groove sidewalls may have an unworn groove sidewall height, and the rounded stone ejectors may each have an ejector height, the ejector height being no greater than about 8 mm.

In any of the above embodiments at least about 75% of the rounded stone ejectors of the tire may have substantially equal shapes and dimensions.

In any of the above embodiments the rounded stone ejectors may include a mixture of rounded stone ejectors of different shapes and dimensions.

In any of the above embodiments the tread groove may extend circumferentially around the tire in a zig-zag pattern including alternating straight portions joined at obtuse corners, and the groove length may be defined along each of the straight portions. The row of rounded stone ejectors may include a plurality of straight elongated rounded stone ejectors in each straight portion of the groove, and a bent elongated rounded stone ejector in each obtuse corner.

In any of the above embodiments each stone ejector may have a height in a range of from about 4 mm to about 8 mm.

In any of the above embodiments the base of the stone ejector may be spaced from the groove sidewalls by a spacing of no greater than about 4 mm.

In any of the above embodiments, junctions between the groove bottom and both the base and groove sidewalls may be curved, and the base of the stone ejector may be sufficiently close to the groove sidewalls such that the groove bottom between the base and groove sidewalls is completely curved.

Numerous objects, features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic cross-section view of a pneumatic tire incorporating rounded stone ejectors.

FIG. 2 is a perspective view of the tread region of the tire of FIG. 1.

FIG. 3A is a schematic cross-section view through one of the tread grooves showing an elliptical or elongated rounded stone ejector in cross-section.

FIG. 3B is a schematic cross-section view through one of the tread grooves showing a spherical stone ejector in cross-section.

FIG. 4A is a schematic plan view taken along line 4A-4A of FIG. 3A showing a row of elliptical or elongated rounded stone ejectors spaced along a length of a tread groove.

FIG. 4B is a schematic plan view taken along line 4B-4B of FIG. 3B showing a row of spherical stone ejectors spaced along a length of a tread groove.

FIG. 4C is a schematic plan view similar to FIGS. 4A and 4B, showing a row of alternating spherical stone ejectors and elliptical or elongated rounded stone ejectors spaced along a length of a tread groove.

### DETAILED DESCRIPTION

Following are definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to directions which are parallel to the axis of rotation of a tire.

“Bead” or “bead core” refers to that part of a tire comprising an annular tensile member, the bead core, wrapped by ply cords and shaped, with or without other reinforcement elements to fit a designed tire rim.

“Belt” or “belt ply” refers to an annular layer or ply of parallel cords, woven or unwoven, underlying the tread, not anchored to the bead.

“Carcass” refers to the tire structure apart from the belt structure, tread, undertread, and sidewall rubber but including the beads, (carcass plies are wrapped around the beads).

“Circumferential” refers to lines or directions extending along the perimeter of the surface of the annular tread perpendicular to the axial direction.

“Cord” means one of the reinforcement strands of which the plies in the tire are comprised.

“Equatorial plane (EP)” refers to a plane that is perpendicular to the axis of rotation of a tire and passes through the center of the tire's tread.

“Ply” means a continuous layer of rubber coated parallel cords.

“Radial” and “radially” refer to directions that are perpendicular to the axis of rotation of a tire.

“Radial-ply” or “radial-ply tire” refers to a belted or circumferentially-restricted pneumatic tire in which the ply cords which extend from bead to bead are laid at cord angles between 65 degree and 90 degree with respect to the equatorial plane of the tire.

“Turn-up height” (TH) means the radial distance from the base of the bead core to the upper end of the turn-up.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. Additionally, the term “radially inner” refers to an element that is closer to the axis of rotation than is a “radially outer” element. The terms “axially inward” and “axially inwardly” refer to a general direction towards the equatorial plane of the tire, whereas “axially outward” and “axially outwardly” refer to a general direction away from the equatorial plane of the tire and towards the sidewall of the tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

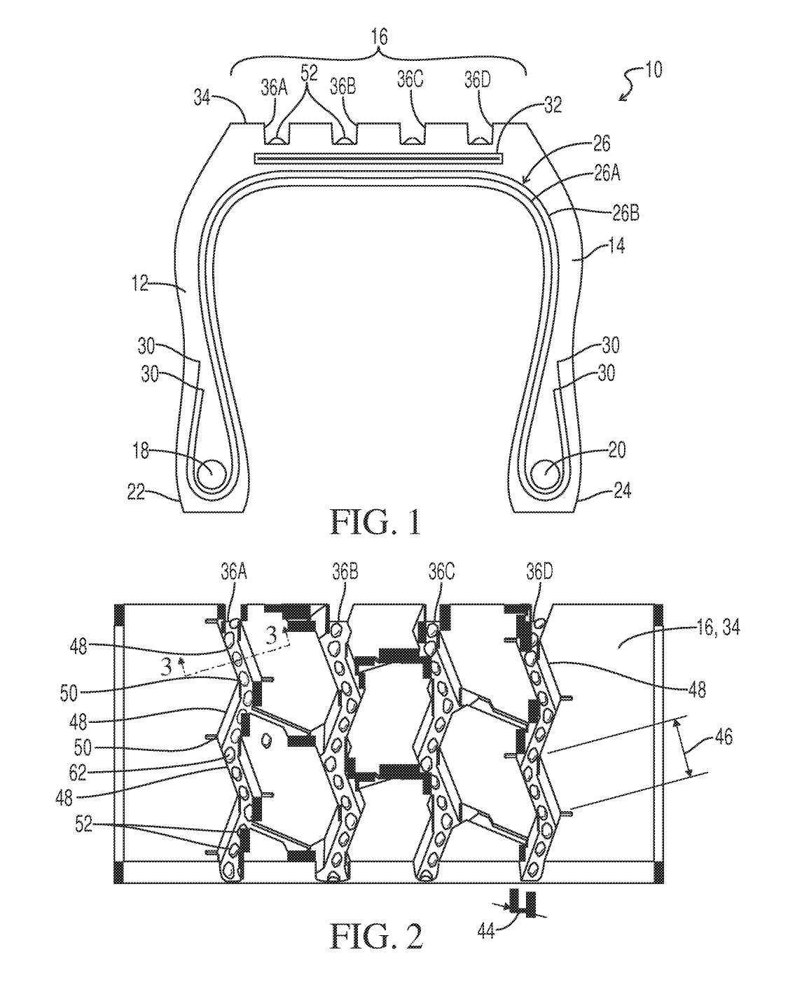

Referring now to FIG. 1, a schematic cross-section view is there shown of a pneumatic tire 10. The tire 10 has first and second sidewalls 12 and 14. A circumferential tread area or tread portion 16 extends between the sidewalls. First and second beads 18 and 20 are located in bead portions 22 and 24 of the first and second sidewalls 12 and 14, respectively. A carcass 26 including one or more body plies 26A and 26B extends through the tread area 16, down through the sidewalls 12 and 14, and wraps around the beads 18 and 20 terminating in turn-up ends 30.

One or more circumferentially extending reinforcing belts, which may be generally referred to as a belt package 32, are placed in the tread portion 16 radially outside of the carcass 26.

The tread portion 16 includes a radially outer ground contacting surface 34 having a plurality of tread grooves 36A, 36B, 36C and 36D therein as seen in FIG. 1.

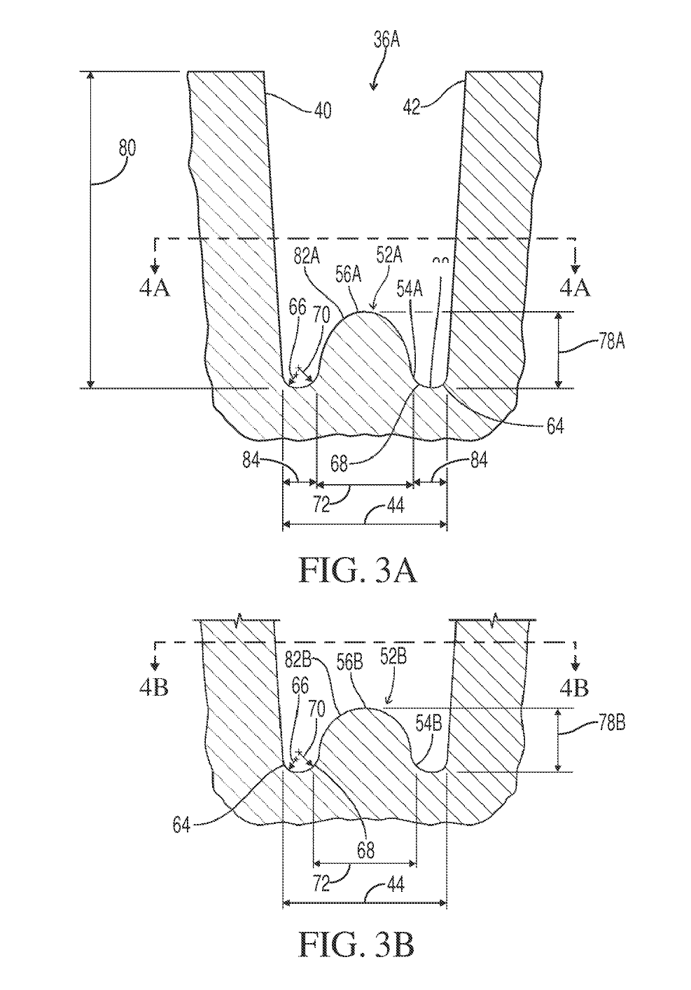

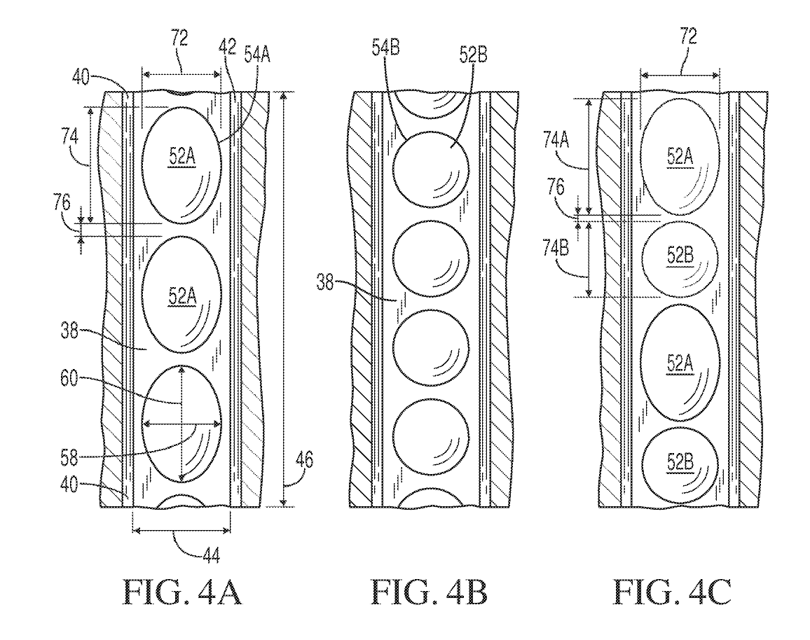

As best seen in the enlarged cross-section view of FIG. 3A, each tread groove such as 36A has a groove bottom 38 and groove sidewalls 40 and 42. The groove 36A has a groove width 44 defined as a shortest width between the groove sidewalls 40 and 42. As best seen in FIGS. 2 and 4A, the groove 36A has a groove length 46 extending generally parallel to the groove sidewalls 40 and 42.

It will be understood that each of the grooves such as 36A extends generally circumferentially around the circumference of the tire 10. The groove 36A may, as shown for example in FIG. 2, extend circumferentially around the tire 10 in a zig-zag pattern including alternating straight portions 48 joined at obtuse corners 50. As indicated in FIG. 2, the groove length 46 may be defined along each of the straight portions 48.

The shape of the grooves 36A, such as the zig-zag shape shown in FIG. 2, are not critical to the concept of the invention. The grooves may for example be completely straight grooves running in a straight fashion circumferentially around the entire circumference of the tire. The grooves may be zig-zag as shown in FIG. 2. The grooves may have other patterns such as various other wavy or zig-zag shapes. In general, the length of the groove refers to a line generally paralleling the sidewalls of the groove and extending generally around the circumference of the tire.

As best seen in FIG. 2, each groove such as 36A may have a row of rounded stone ejectors 52 spaced apart along the groove length 46. The elongated rounded or elliptical stone ejector of FIG. 3A is designated as 52A. The spherical stone ejector of FIG. 3B is indicated as 52B. As used herein, a reference to a stone ejector 52 generically refers to both 52A and 52B. The same is true of references to analogous parts of the stone ejectors 52.

As best seen in the enlarged view of FIGS. 3A and 3B, each of the stone ejectors 52 has a base 54 attached to the groove bottom 38 and independent from the groove sidewalls 40 and 42. Each rounded stone ejector 52 has a rounded peak 56 and is continuously tapered from the base 54 to the rounded peak 56. In preferred embodiments such as seen in FIGS. 3A and 3B, the rounded stone ejectors are also continuously rounded from the base 54 to the rounded peak 56. Alternatively, some portion of the sides of the stone ejector could be straight tapered sides rather than being continuously rounded, and the same would be considered to be continuously tapered although not necessarily continuously rounded in the vertical direction.

In the embodiment seen in FIG. 4A, the base 54A of each stone ejector 52A is generally elliptical in shape and has a minimum axis 58 substantially parallel to the groove width 44 and has a maximum axis 60 substantially parallel to the groove length 46.

In one embodiment of the elliptical stone ejector 52A, the elliptical stone ejector is shaped as a rotation of the elliptical base 54A about the minimum axis 58, such that the cross-section of the elliptical stone ejector 52A seen in a heightwise section such as FIG. 3A is substantially identical in profile to one half of the elliptical base 54A seen in FIG. 4A.

The elliptical stone ejectors 52A may be more generally referred to as elongated rounded stone ejectors 52A. The base 54A of each elongated rounded stone ejector 52A is elongated along the groove length 46 and has rounded ends.

The elongated rounded stone ejectors 52A may be generally described as having a base length 74 and a base width 72, the base width continuously tapering from a maximum base width to each of the rounded ends. The maximum base width may occur at a midpoint of the base length.

Another form of rounded stone ejector 52 is that depicted in FIGS. 3B and 4B as a spherical stone ejector 52B. The spherical stone ejector 52B has a base 54B which is generally circular in shape. The spherical stone ejector 52B is generally shaped as a portion of a sphere, for example as one half of a sphere.

In general, the base 54A of the elliptical or elongated rounded stone ejector 52A and the base 54B of the spherical stone ejector 52B may both be described as having a periphery that is entirely smooth and free of any abrupt changes in tangential direction. That is contrasted to many prior art stone ejectors which in plan view have sharp corners, such as generally rectangular shaped stone ejectors.

Thus, the term “rounded stone ejectors” may include elongated rounded stone ejectors such as 52A and spherical rounded stone ejectors such as 52B. Within the group of elongated rounded stone ejectors 52A, the stone ejector may be elliptical, but may also more generally just be of an elongated shape having rounded ends and need not be precisely elliptical.

Additionally, it is noted as shown in FIG. 2, that when using a tire having a groove 36A in a zig-zag pattern having obtuse corner 50, the row of rounded stone ejectors may include a bent elongated rounded stone ejector 62 located in each obtuse corner, with the bend in the elongated stone ejector 62 generally corresponding to the angle of the obtuse corner 50.

It is further noted as seen in FIGS. 3A and 3B, that the junctions such as 64 between the groove bottom 38 and the sidewalls 40 and 42 are preferably radiused so as to have a radius of curvature 66. Also, the junctions such as 68 between the groove bottom 38 and the base 54 are radiused to have a radius of curvature such as 70. The radiused junctions are provided in order to prevent stress concentrations at those junctions and thus prevent cracking of the tire.

In one embodiment, the width 72 of the base is selected so that the base 54 of the stone ejector 52 is sufficiently close to the groove sidewalls 40 and 42 such that the groove bottom 38 between the base 54 and the groove sidewalls 40 and 42 is completely curved as is generally seen in FIGS. 3A and 3B.

It is noted that due to the radius 70 at the junction 68 of the base 54 of stone ejector 52 with the groove bottom 38, there is not necessarily any distinct break line identifying the periphery of base 54. Accordingly, the ejector width 72 and ejector length 74 are the length and width of the nominal base periphery which would exist if the junction 68 were not rounded and if the tapered side walls of the stone ejectors intersected a flat groove bottom without any radiusing 70.

As best seen in FIG. 4A, adjacent elliptical stone ejectors 52A may be spaced apart by a spacing 76 which is preferably less than a width 72 of the base of either adjacent stone ejector 52A. The spacing 76 may be less than 5 mm, and more preferably less than about 2.5 mm.

As seen in FIGS. 3A and 3B, the elliptical stone ejector 52A has a height 78A, and the spherical stone ejector 52B has a height 78B. For the elliptical stone ejector 52A the height 78A will be equal to one half the length 74A, and for the spherical stone ejector 52B, the height 78B will be equal to one half the length 74B, which will be equal to the radius of the spherical shape defining the spherical stone ejector. The ejector height 78 may for example be in a range of from about 4 mm to about 8 mm, and more preferably may be about 6 mm.

Either an elliptical or spherical stone ejector has an exterior surface 82, all portions of which in vertical direction are continuously rounded and continuously tapered from the base 54 at the groove bottom 38 to the rounded peak 56. The rounded stone ejectors 52 provided herein provide multiple angles on their outer surface 82 to help eject stones from the groove bottom 38.

The ejector 52 may be spaced from the groove sidewalls 40 and 42 by a spacing 84 of no greater than about 4 mm in an embodiment.

The spacing 84 may be selected to be as small as possible while still allowing room to provide the radiused junctions 64 and 68 with the groove bottom 38. This maximizes the size and effect of the rounded stone ejector, while still maintaining its independence from the sidewalls 40 and 42.

The height 78 may be selected so as to be tall enough to provide a substantial stone ejection effect, while still not being so large as to substantially impact the water control capability of the groove 36. It is noted that the height 78A of the elliptical stone ejector 52A is taller than the height 78B of the spherical stone ejector 52B for equal stone ejector widths 72.

As seen in FIG. 3A, when the tire 10 is in a new unworn condition, the groove sidewalls 40 and 42 have an unworn groove sidewall height 80.

As seen in FIG. 2, in one embodiment the vast majority of the stone ejectors 36 may have substantially equal shapes and dimensions. For example, at least 75% of the rounded stone ejectors may have substantially equal shapes and dimensions.

Alternatively, as shown for example in FIG. 4C, the row of rounded stone ejectors may include a mixture of rounded stone ejectors of different shapes and dimensions, for example alternating elliptical stone ejectors 52A and spherical stone ejectors 52B. Other assortments or patterns of stone ejectors of different shapes and dimensions may be utilized.

Thus it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art which changes are encompassed within the scope and spirit of the present invention as defined by the appended claims.

What is claimed is:

1. A pneumatic tire, comprising:
a tread portion including a tread groove having a groove bottom and groove sidewalls, the groove having a groove length extending generally parallel to the groove sidewalls; and
a row of rounded stone ejectors spaced apart along the groove length, each of the rounded stone ejectors having a base attached to the groove bottom and independent from the groove sidewalls, each rounded stone ejector having a rounded peak and being continuously tapered from the base to the rounded peak.

2. The tire of claim 1, wherein:
at least some of the rounded stone ejectors are continuously rounded from the base to the rounded peak.

3. The tire of claim 1, wherein:
the base has a periphery, and for at least some of the rounded stone ejectors the entire periphery of the base is smooth and free of any abrupt changes in tangential direction.

4. The tire of claim 1, wherein:
at least some of the rounded stone ejectors are spherical stone ejectors shaped as a portion of a sphere and the base of each spherical stone ejector is circular.

5. The tire of claim 1, wherein:
at least some of the rounded stone ejectors are elongated rounded stone ejectors, and the base of each elongated rounded stone ejector is elongated along the groove length and has rounded ends.

6. The tire of claim 5, wherein:
the groove has a groove width defined as a shortest distance between the groove sidewalls, and
at least some of the elongated rounded stone ejectors are elliptical stone ejectors, the base of each elliptical stone ejector being generally elliptical in shape having a minimum axis substantially parallel to the groove width and having a maximum axis substantially parallel to the groove length.

7. The tire of claim 6, wherein:
each of the elliptical stone ejectors is shaped as a rotation of the elliptical base about the minimum axis of the base.

8. The tire of claim 5, wherein:
the base of each of the elongated rounded stone ejectors has a base length and a base width, the base width having a maximum base width in a central portion of the base length, and the base width continuously tapering from the maximum base width to each of the rounded ends.

9. The tire of claim 8, wherein:
the maximum base width occurs at a mid-point of the base length.

10. The tire of claim 1, wherein:
adjacent rounded stone ejectors are spaced apart by a spacing less than a width of the base of either adjacent rounded stone ejector.

11. The tire of claim 1, wherein:
each of the rounded stone ejectors are substantially equally spaced from each of the groove sidewalls, and junctions between the groove bottom and both the base and the groove sidewalls are radiused such that the groove bottom between the base and the groove sidewalls is completely curved.

12. The tire of claim 1, wherein:
the rounded stone ejectors each have an ejector height, the ejector height being no greater than about 8 mm.

13. The tire of claim 1, wherein:
at least 75% of the rounded stone ejectors of the tire have substantially equal shapes and dimensions.

14. The tire of claim 1, wherein:
the rounded stone ejectors include a mixture of rounded stone ejectors of different shapes and dimensions.

15. The tire of claim 1, wherein:
the tread groove extends circumferentially around the tire in a zig-zag pattern including alternating straight portions joined at obtuse corners, and the groove length is defined along each of the straight portions; and
the row of rounded stone ejectors includes a plurality of straight elongated rounded stone ejectors in each straight portion of the groove and a bent elongated rounded stone ejector in each obtuse corner.

16. A pneumatic tire, comprising:
a tread portion having a groove defined therein, the groove having a groove cross-section defined by a groove bottom and opposed groove sidewalls; and
a stone ejector extending upward from the groove bottom and not contacting the groove sidewalls, the stone ejector having an exterior surface, all portions of the exterior surface being in vertical direction continuously rounded and continuously tapered from a base at the groove bottom to a rounded peak.

17. The tire of claim 16, wherein:
the base is an elongated base having a base length extending generally parallel to the groove sidewalls.

18. The tire of claim 16, wherein:
the stone ejector has a height in a range of from about 4 mm to about 8 mm.

19. The tire of claim 16, wherein:
the base of the stone ejector is spaced from the groove sidewalls by a spacing of no greater than about 4 mm.

20. The tire of claim 16, wherein:
junctions between the groove bottom and both the base and the groove sidewalls are curved, and the base of the stone ejector is sufficiently close to the groove sidewalls such that the groove bottom between the base and the groove sidewalls is completely curved.
